(19) United States
(12) Patent Application Publication
(10) Pub. No.: US 2009/0228858 A1
(43) Pub. Date: Sep. 10, 2009

(54) CIRCUIT-DESIGNING SUPPORT SYSTEM, METHOD OF DISPLAYING IN CIRCUIT- DESIGNING SUPPORT SYSTEM, AND COMPUTER-READABLE RECORDING MEDIUM

(76) Inventor: YASUCHIKA HARUTA, Tokyo (JP)

Correspondence Address: NEC CORPORATION OF AMERICA, 6535 N. STATE HWY 161, IRVING, TX, 75039, US

(21) Appl. No.: 12/398,313

(22) Filed: Mar. 5, 2009

(30) Foreign Application Priority Data
Mar. 6, 2008 (JP) 2008-0056040

(51) Int. Cl. G06F 17/50

(52) U.S. Cl. 716/18

(57) ABSTRACT

A circuit-designing support system performs a behavioral synthesis process based on an input behavior level description and creates a register transfer (RT) level description. The system causes a behavior level description display unit to display the behavior level description and causes an RT level description display unit to display the RT level description. As a user specifies one or plural arbitrary rows of the behavior level description, the circuit-designing support system causes the behavior level description display unit to display the specified row in such a manner as to be distinguished from other rows. The system searches a row of the RT level description corresponding to the specified row of the behavior level description, and causes the RT level description display unit to display the searched row of the RT level description in such a manner as to be distinguished from other rows.

This application is based on Japanese Patent Application No. 2008-056040 filed on Mar. 6, 2008 and including specification, claims, drawings and summary. The disclosure of the above Japanese Patent Application is incorporated herein by reference in its entirety.

### BACKGROUND OF THE INVENTION

1. Field of the Invention

The present invention relates to a circuit-designing support system for supporting circuit designing, a method of displaying in the circuit-designing support system and a computer-readable recording medium storing a program for supporting circuit designing.

2. Description of the Related Art

Presently, circuit-designing support systems for supporting designing of a semiconductor integrated circuit, such as an LSI or a VLSI have been in practical use. Such circuit-designing support systems execute a behavioral synthesis process based on a behavior level description described in the C language, the C++ language, the java language, or the like. Thereafter, such systems output a register transfer (RT) level description described in the form of a circuit diagram constituted by nodes, such as a computing unit, a register, and input/output terminals.

According to the conventional technology, however, because only the result of a behavioral synthesis process is displayed, it is not possible to compare a behavior level description with an RT level description.

Therefore, it is not convenient for users.

### SUMMARY OF THE INVENTION

The present invention has been made in view of the foregoing problem, and it is an object of the present invention to provide a circuit-designing support system having a high convenience, a method of displaying in the system, and a computer-readable recording medium storing a program for supporting circuit designing highly conveniently.

In order to achieve the object, a circuit-designing support system according to the first aspect of the invention performs behavioral synthesis based on a behavior level description comprised of one or plural rows, and outputs a register transfer level description comprised of one or plural rows, and the system comprises:

a behavior level display unit that displays the behavior level description;

a register transfer level display unit that displays the register transfer level description;

a specifying unit that specifies one or plural arbitrary rows of the behavior level description displayed by the behavior level display unit;

a behavior level display control unit that causes the behavior level display unit to display the row of the behavior level description specified by the specifying unit with the specified row being distinguished from other rows;

a searching unit that searches a row of the register transfer level description corresponding to the row of the behavior level description specified by the specifying unit; and

a register transfer level display control unit that causes the register transfer level display unit to display the row of the register transfer level description searched by the searching unit with the searched row being distinguished from other rows.

A circuit-designing support system according to the second aspect of the present invention performs behavioral synthesis based on a behavior level description comprised of one or plural rows, and outputs a register transfer level description comprised of one or plural rows, and the system comprises:

a behavior level display unit that displays the behavior level description;

a register transfer level display unit that displays the register transfer level description;

a specifying unit that specifies one or plural arbitrary rows of the register transfer level description displayed by the register transfer level display unit;

a register transfer level display control unit that causes the register transfer level display unit to display the row of the register transfer level description specified by the specifying unit with the specified row being distinguished from other rows;

a searching unit that searches a row of the behavior level description corresponding to the row of the register transfer level description specified by the specifying unit; and

a behavior level display control unit that causes the behavior level display unit to display the row of the behavior level description searched by the searching unit with the searched row being distinguished from other rows.

A method of displaying in a circuit-designing support system according to the third aspect of the present invention is a display method of the circuit-designing support system which performs behavioral synthesis based on a behavior level description comprised of one or plural rows, outputs a register transfer level description comprised of one or plural rows, and displays the register transfer level description on a display device, the method comprises:

a behavior level display step of displaying the behavior level description on the display device;

a register transfer level display step of displaying the register transfer level description on the display device;

a specifying step of specifying one or plural arbitrary rows of the behavior level description displayed on the display device; and

a searching step of searching a row of the register transfer level description corresponding to the row of the behavior level description specified in the specifying step, and wherein:

in the behavior level display step, the row of the behavior level description specified in the specifying step is displayed on the display device while the specified row being distinguished from other rows; and

in the register transfer level display step, the row of the register transfer level description searched in the searching step is displayed on the display device with the searched row being distinguished from other rows.

A method of displaying in a circuit-designing support system according to the fourth aspect of the present invention is a display method of the circuit-designing support system which performs behavioral synthesis based on a behavior level description comprised of one or plural rows, outputs a register transfer level description comprised of one or plural rows, and displays the register transfer level description on a display device, the method comprises:

a behavior level display step of displaying the behavior level description on the display device;

a register transfer level display step of displaying the register transfer level description on the display device;

a specifying step of specifying one or plural arbitrary rows of the register transfer level description displayed on the display device; and

a searching step of searching a row of the behavior level description corresponding to the row of the register transfer level description specified in the specifying step, and wherein:

in the register transfer level display step, the row of the register transfer level description specified in the specifying step is displayed on the display device while the specified row being distinguished from other rows; and

in the behavior level display step, the row of the behavior level description searched in the searching step is displayed on the display device with the searched row being distinguished from other rows.

A computer-readable recording medium according to the fifth aspect of the present invention stores a program that allow a computer, which performs behavioral synthesis based on a behavior level description comprised of one or plural rows, outputs a register transfer level description comprised of one or plural rows, and displays the register transfer level description on a display device, to function as:

a behavior level display control unit that displays the behavior level description on the display device;

a register transfer level display control unit that displays the register transfer level description on the display device;

a specifying unit that specifies one or plural arbitrary rows of the behavior level description displayed on the display device; and

a searching unit that searches a row of the register transfer level description corresponding to the row of the behavior level description specified by the specifying unit, and wherein:

the behavior level display control unit displays the row of the behavior level description specified by the specifying unit on the display device while the specified row being distinguished from other rows; and

the register transfer level display control unit displays the row of the register transfer level description searched by the searching unit on the display device with the searched row being distinguished from other rows.

A computer-readable recording medium according to the sixth aspect of the present invention stores a program that allow a computer, which performs behavioral synthesis based on a behavior level description comprised of one or plural rows, outputs a register transfer level description comprised of one or plural rows, and displays the register transfer level description on a display device, to function as:

a behavior level display control unit that displays the behavior level description on the display device;

a register transfer level display control unit that displays the register transfer level description on the display device;

a specifying unit that specifies one or plural arbitrary rows of the register transfer level description displayed on the display device; and

a searching unit that searches a row of the behavior level description corresponding to the row of the register transfer level description specified by the specifying unit, and wherein:

the register transfer level display control unit displays the row of the register transfer level description specified by the specifying unit on the display device while the specified row being distinguished from other rows; and

the behavior level display control unit displays the row of the behavior level description searched by the searching unit on the display device with the searched row being distinguished from other rows.

### BRIEF DESCRIPTION OF THE DRAWINGS

The object and other objects and advantages of the present invention will become more apparent upon reading of the following detailed description and the accompanying drawings in which:

FIG. 1 is a configuration diagram of a circuit-designing support system according to an embodiment of the present invention;

FIG. 2A is a diagram showing an example of a display screen displayed by a behavior level description display unit of an output device in FIG. 1;

FIG. 2B is a diagram showing an example of a display screen displayed by an RT level description display unit of the output device in FIG. 1;

FIG. 3 is a diagram for explaining correspondence information stored in a storing device in FIG. 1;

FIG. 4A is a diagram showing an example of a display screen displayed by the RT level description display unit when a row of an RT level description is selected;

FIG. 4B is a diagram showing an example of a display screen displayed by the behavior level description display unit when a row of an RT level description is selected;

FIG. 5A is a diagram showing an example of a display screen displayed by the behavior level description display unit when a row of a behavior level description is selected;

FIG. 5B is a diagram showing an example of a display screen displayed by the RT level description display unit when a row of a behavior level description is selected;

FIG. 6A is a diagram showing an example of a display screen displayed by the RT level description display unit when plural rows of an RT level description are selected;

FIG. 6B is a diagram showing an example (No. 1) of a display screen displayed by the behavior level description display unit when plural rows of an RT level description are selected;

FIG. 6C is a diagram showing an example (No. 2) of a display screen displayed by the behavior level description display unit when plural rows of an RT level description is selected;

FIG. 7 is a flowchart for explaining a behavioral synthesis process; and

FIG. 8 is a flowchart for explaining a display control process.

### DETAILED DESCRIPTION OF THE PREFERRED EMBODIMENT

An explanation will be given of a circuit-designing support system 1000 according to an embodiment of the present invention. The circuit-designing support system 1000 executes a behavioral synthesis process based on a behavior level description described in the C language, and outputs an RT (Register Transfer) level description.

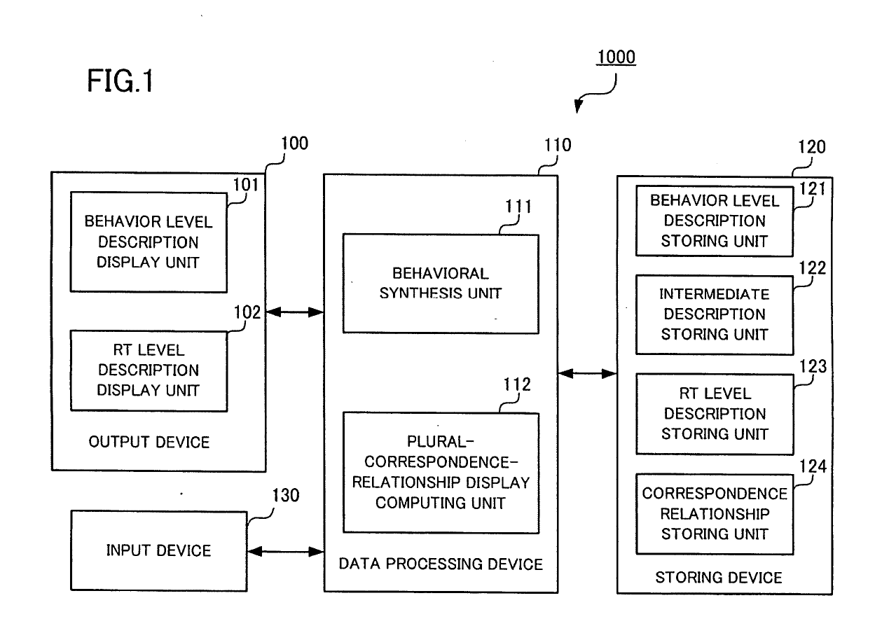

As shown in FIG. 1, the circuit-designing support system 1000 comprises an output device 100, a data processing device 110, a storing device 120, and an input device 130.

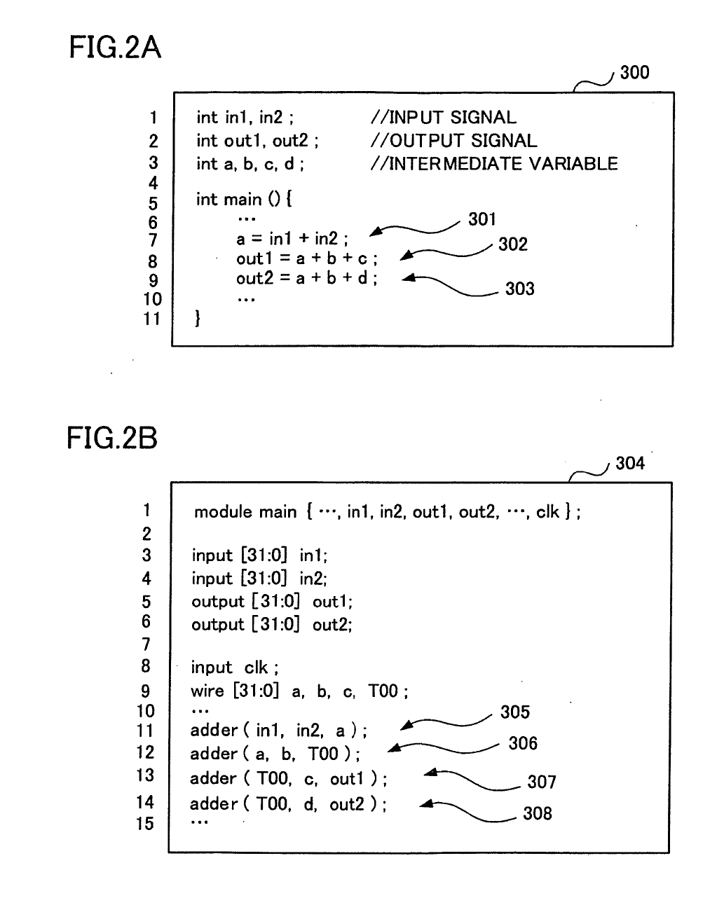

The output device 100 has a behavior level description display unit 101 and an RT level description display unit 102. The behavior level description display unit 101 displays a behavior level description like, for example, a display screen 300 shown in FIG. 2A. The RT level description display unit 102 displays an RT level description like, for example, a display screen 304 shown in FIG. 2B.

The data processing device 110 has a behavioral synthesis unit 111 and a plural-correspondence-relationship display computing unit 112.

The behavioral synthesis unit 111 executes a behavioral synthesis process based on a behavior level description stored in a behavior level description storing unit 121 to be discussed later.

The behavioral synthesis unit 111 creates an intermediate level description during a behavioral synthesis process, and stores the created intermediate level description in an intermediate description storing unit 122 to be discussed later.

Moreover, the behavioral synthesis unit 111 creates an RT level description as a result of a behavioral synthesis process, and stores the created RT level description in an RT level description storing unit 123 to be discussed later. The behavioral synthesis unit 111 causes the RT level description display unit 102 to display the RT level description.

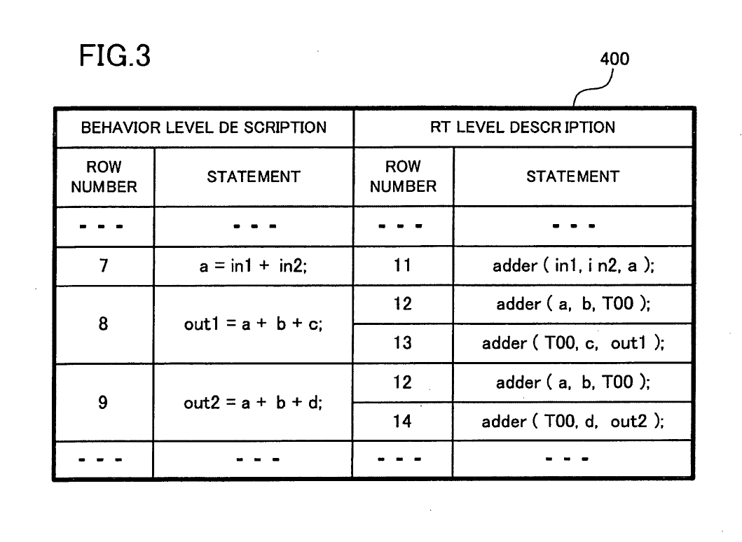

Furthermore, the behavioral synthesis unit 111 creates correspondence information 400 (see FIG. 3), indicating the correspondence relationship between an RT level description and a behavior level description, as a result of a behavioral synthesis process, and stores the created correspondence information 400 in a correspondence relationship storing unit 124 to be discussed later.

As shown in FIG. 3, the correspondence information 400 is constituted by items of row numbers of all rows of a behavior level description and items of statements of the behavior level description, and the items of row numbers of rows of an RT level description and the items of statements of the RT level description, corresponding to the behavior level description row by row.

For example, “a=in1+in2;” in the seventh row of the behavior level description is a statement of adding the value of a variable in1 and the value of a variable in2 and substituting such a sum into a variable a. The seventh row of the behavior level description corresponds to the eleventh row of the RT level description. “adder (in1, in2, a);” in the eleventh row of the RT level description indicates an adder which adds a signal in1 and a signal in2 to output a signal a.

Moreover, “out1=a+b+c;” in the eighth row of the behavior level description is a statement of adding the value of a variable a, the value of a variable b and the value of a variable c, and substituting such a sum into a variable out1. The eighth row of the behavior level description corresponds to the twelfth and thirteenth rows of the RT level description. “adder (a, b, T00);” in the twelfth row of the RT level description indicates an adder which adds a signal a and a signal b to output a signal T00, and “adder (T00, c, out1);” in the thirteenth row of the RT level description indicates an adder which adds the signal T00 and a signal c to output a signal out1. That is, when the adder “adder (a, b, T00);” and the adder “adder (T00, c, out1);” are combined together, an adder which adds a signal a, a signal b, and a signal c to output a signal out1 is created.

The plural-correspondence-relationship display computing unit 112 searches one or plural rows of an RT level description or a behavior level description corresponding to one or plural rows of a behavior level description or an RT level description selected by a user through the input device 130 from the correspondence information 400.

The plural-correspondence-relationship display computing unit 112 causes the RT level description display unit 102 or the behavior level description display unit 101 to display an RT level description or a behavior level description with the searched row being distinguished from other rows.

The storing device 120 has the behavior level description storing unit 121, the intermediate description storing unit 122, the RT level description storing unit 123, and the correspondence relationship storing unit 124.

The behavior level description storing unit 121 stores a behavior level description, the intermediate description storing unit 122 stores an intermediate level description, the RT level description storing unit 123 stores an RT level description, and the correspondence relationship storing unit 124 stores the correspondence information 400.

The input device 130 receives an inputting operation of a behavior level description by the user. The input behavior level description is stored in the behavior level description storing unit 121.

The input device 130 receives a selection operation of one or plural rows of a behavior level description or an RT level description by the user displayed on the behavior level description display unit 101 or the RT level description display unit 102.

The row selected by the user through the input device 130 in a behavior level description or an RT level description is displayed on the behavior level description display unit 101 or the RT level description display unit 102 while the selected row being distinguished from other rows.

Next, an explanation will be given of the operation of the circuit-designing support system having the foregoing structure.

The circuit-designing support system 1000 causes the data processing device 110 to execute a behavioral synthesis process based on a behavior level description input by the user through the input device 130, thereby creating an RT level description. The system 1000 causes the behavior level description display unit 101 to display the behavior level description and the RT level description display unit 102 to display the RT level description.

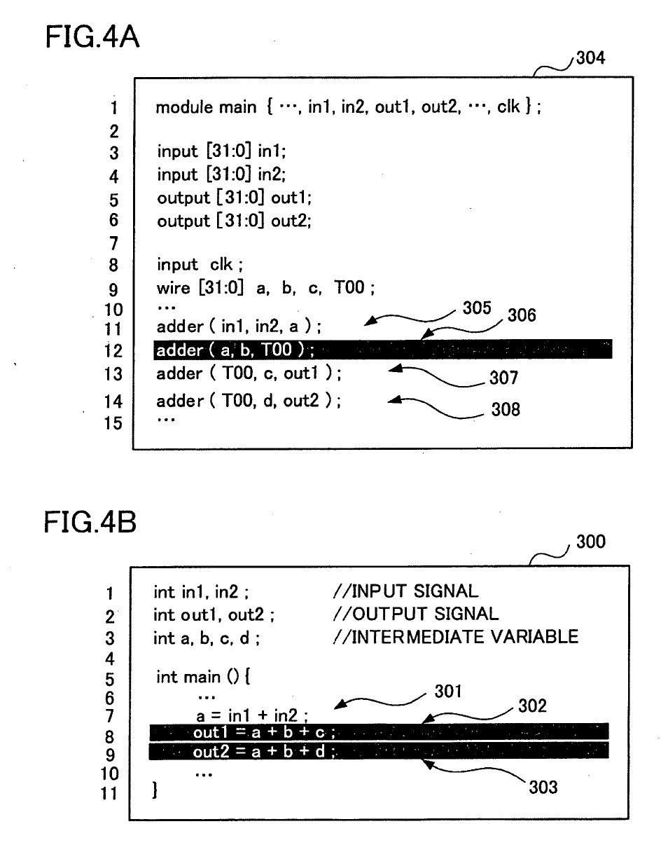

When an RT level description is displayed on the RT level description display unit 102, if a desired row is selected by the user through the input device 130, the circuit-designing support system 1000 causes the RT level description display unit 102 to display the selected row while distinguishing the selected row from other rows. For example, in a display screen 304 shown in FIG. 4A, a twelfth row 306 selected by the user is highlighted and distinguished from other rows so that the user can easily view it.

The circuit-designing support system 1000 causes the data processing device 110 to search the row of the behavior level description corresponding to the row of the selected RT level description. In order to let the user to easily differentiate the searched row, the behavior level description display unit 101 displays the searched row in such a manner as to be distinguished from other rows. In the example shown in FIG. 4B, the eighth and ninth rows 302, 303 of the behavior level description correspond to the row 306 in FIG. 4A, and are highlighted so as to be distinguished from other rows.

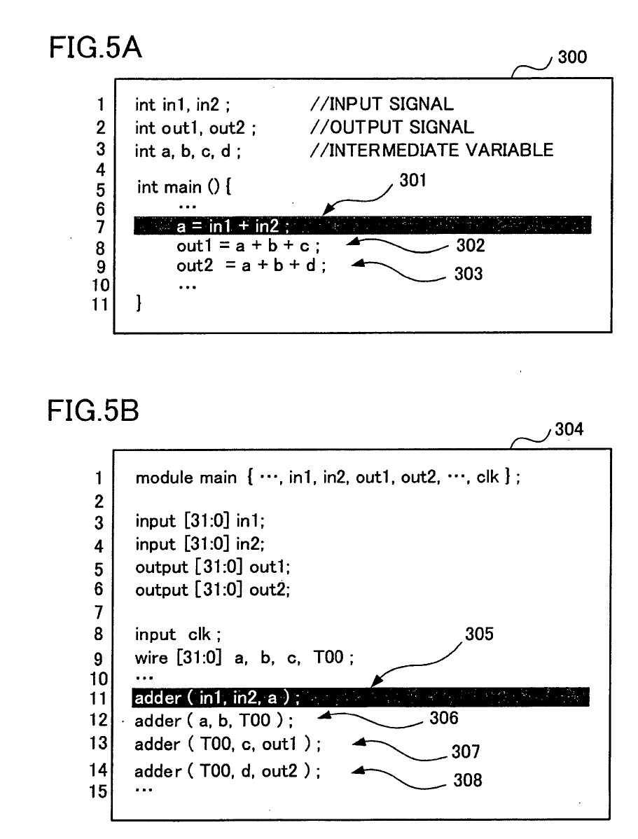

When a desired row of the behavior level description is selected by the user, the circuit-designing support system 1000 causes the behavior level description display unit 101 to display the selected row while distinguishing such a row from other rows so that the user can easily view the selected row. For example, in a display screen 300 shown in FIG. 5A, a seventh row 301 selected by the user is highlighted so as to be distinguished from other rows.

Moreover, the circuit-designing support system 1000 causes the data processing device 110 to search a row of the RT level description corresponding to the selected row of the behavior level description. In order to let the user to easily differentiate the searched row, the RT level description display unit 102 displays the searched row in such a manner as to be distinguished from other rows. For example, in FIG. 5B, an eleventh row 305 of the RT level description corresponds to the row 301 in FIG. 5A, and is highlighted so as to be distinguished from other rows.

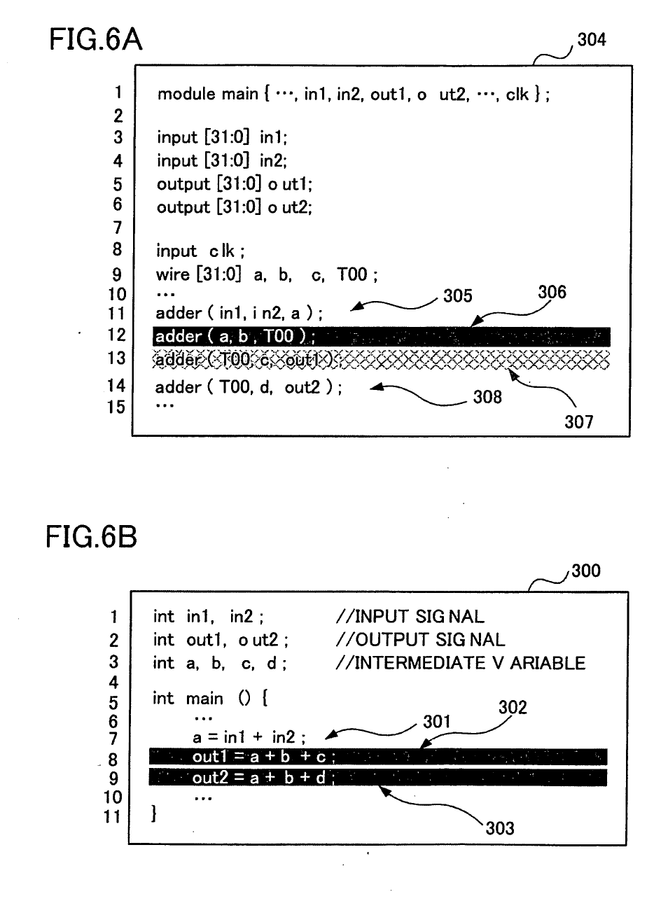

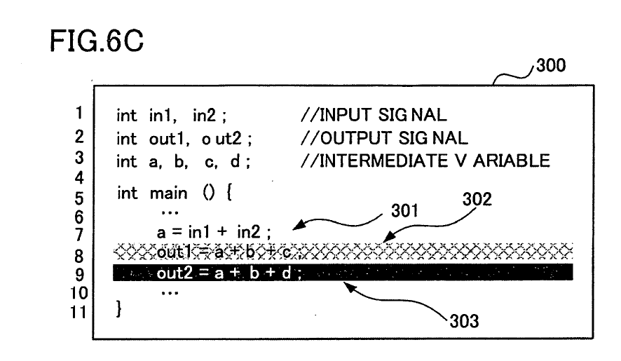

When the user selects plural rows through the input device 130, the circuit-designing support system 1000 causes the output device 100 to display such rows while distinguishing such rows from each other so that the user can easily view the selected plural rows. Thereafter, the circuit-designing support system 1000 causes the data processing device 110 to search the respective corresponding rows of the selected plural rows. In order to let the user to easily differentiate, the circuit-designing support system 1000 causes the output device 100 to display the searched rows while distinguishing each of the searched rows from other rows. For example, in a display screen 304 shown in FIG. 6A, a row 306 in twelfth and thirteenth rows 306, 307 selected by the user is highlighted with a black background and with white characters, and the row 307 therein is highlighted with a meshed background and with black characters so as to be distinguished from other rows.

Moreover, in FIG. 6B, eighth and ninth rows 302, 303 of the behavior level description correspond to the row 306 in FIG. 6A, and like the row 306, are highlighted with a black background and with white characters so as to be distinguished from other rows.

Furthermore, in FIG. 6C, an eighth row 302 in the behavior level description corresponds to the row 307 in FIG. 6A, and like the row 307, are highlighted with a meshed background and with black characters. The screens of FIG. 6B and FIG. 6C are alternately switched and displayed so that the user can easily understand which rows of the behavior level description correspond to the respective rows 306, 307 of the RT level description.

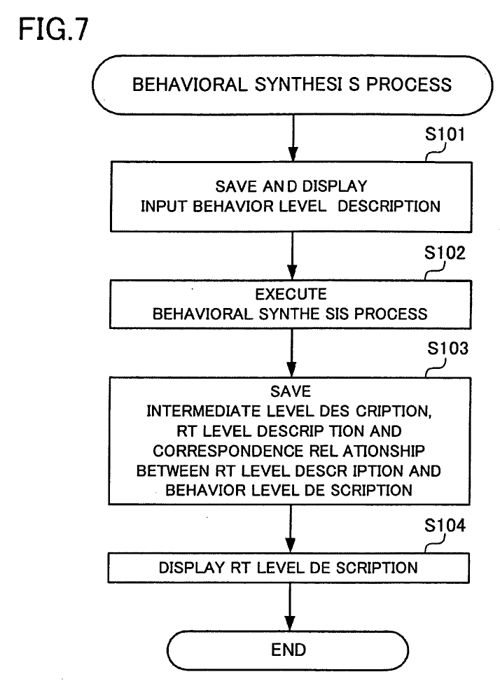

Next, an explanation will be given of the behavioral synthesis process in detail executed by the circuit-designing support system 1000 according to the embodiment of the present invention with reference to the flowchart of FIG. 7.

As a user input a behavior level description through the input device 130, the data processing device 110 transfers the input behavior level description to the behavior level description storing unit 121 and stores such a description therein, and the behavior level description display unit 101 displays the input behavior level description (step S101). The user can edit the displayed behavior level description through the input device 130.

After the behavior level description is input, as the user inputs a request of starting a behavioral synthesis process through the input device 130, the behavioral synthesis unit 111 of the data processing device 110 executes a behavioral synthesis process based on the behavior level description stored in the behavior level description storing unit 121 (step S102).

The behavioral synthesis unit 111 stores an intermediate level description acquired through the behavioral synthesis process in the intermediate description storing unit 122, stores an RT level description acquired as a result of the behavioral synthesis process in the RT level description storing unit 123, and stores correspondence information 400 indicating a correspondence relationship between the RT level description and the behavior level description in the correspondence relationship storing unit 124 (step S103). The intermediate level description stored in the intermediate description storing unit 122 is used for an analysis of a behavioral synthesis process for example.

The behavioral synthesis unit 111 causes the RT level description display unit 102 to display the stored RT level description (step S104), and completes the process.

As explained above, according to the behavioral synthesis process of the embodiment, the circuit-designing support system 1000 creates an RT level description based on an input behavior level description, and outputs both descriptions to the output device 100.

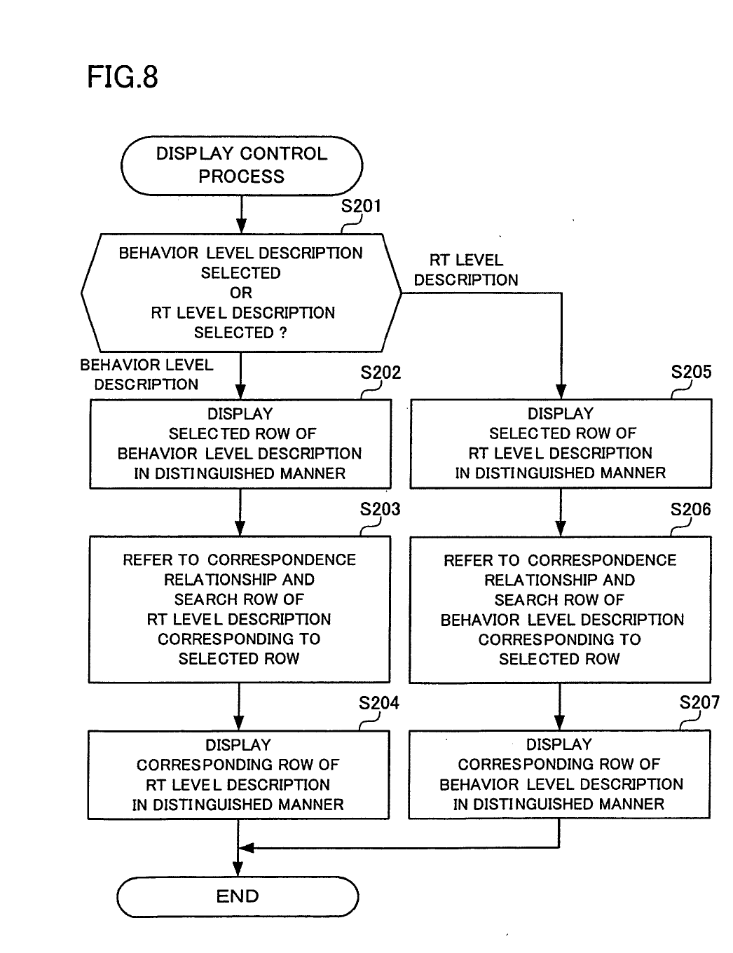

Next, an explanation will be given of the display control process in detail executed by the circuit-designing support system 1000 according to the embodiment of the present invention with reference to the flowchart of FIG. 8.

As the user selects a row of a behavior level description or an RT level description through the input device 130, the plural-correspondence-relationship display computing unit 112 of the data processing device 110 determines whether a row of the behavior level description is selected or a row of the RT level description is selected (step S201).

When determining that a row of the behavior level description is selected (S201: behavior level description), the plural-correspondence-relationship display computing unit 112 causes the behavior level description display unit 101 to display the selected row in such a manner as to be distinguished from other rows so that the user can easily view such a row (step S202).

Thereafter, the plural-correspondence-relationship display computing unit 112 refers to the correspondence information 400 stored in the correspondence relationship storing unit 124 of the storing device 120, and searches a row of the RT level description corresponding to the selected row of the behavior level description (step S203).

The plural-correspondence-relationship display computing unit 112 causes the RT level description display unit 102 to display the searched row of the RT level description in such a manner as to be distinguished from other rows so that the user can easily differentiate such a row (step S204), and completes the process.

On the other hand, when it is determined in the step S201 that a row of the RT level description is selected (step S201: RT level description), the plural-correspondence-relationship display computing unit 112 causes the RT level description display unit 102 to display the selected row in such a manner as to be distinguished from other rows so that the user can easily view such a row (step S205).

Thereafter, the plural-correspondence-relationship display computing unit 112 refers to the correspondence information 400 stored in the correspondence relationship storing unit 124 of the storing device 120, and searches a row of the behavior level description corresponding to the selected row of the RT level description (step S206).

The plural-correspondence-relationship display computing unit 112 causes the behavior level description display unit 101 to display the searched row of the behavior level description in such a manner as to be distinguished from other rows so that the user can easily differentiate such a row (step S207), and completes the process.

As explained above, according to the display control process of the embodiment, the circuit-designing support system 1000 searches a row of an RT level description or a behavior level description corresponding to a selected row of a behavior level description or an RT level description, and displays the searched row in such a manner as to be distinguished from other row, like highlighting, so that the user can easily differentiate such a row.

As explained above, the circuit-designing support system 1000 according to the embodiment of the present invention creates an RT level description on the basis of an input behavior level description, and causes the output device to display both behavior level description and RT level description. The system 1000 searches a row of the RT level description or the behavior level description corresponding to the row of the behavior level description or the RT level description selected by the user, and displays the searched row in such a manner as to be distinguished from other rows so as to make the user to easily differentiate such a row. Accordingly, the user can easily figure out the correspondence relationship between each row of the behavior level description and each row of the RT level description created based on the behavior level description. Therefore, the user can efficiently compare the behavior level description with the RT level description when designing a circuit, resulting in improvement of the work efficiency.

Further, the circuit-designing support system 1000 accepts selection of plural rows of a behavior level description (or an RT level description) by the user, and displays the plural rows selected by the user on the behavior level description display unit 101 (or the RT level description display unit 102) in such a manner as to be individually distinguished from other rows. Thereafter, the system 1000 searches a row of the RT level description (or the behavior level description) corresponding to each of the plural rows selected by the user, and displays the searched plural rows on the RT level description display unit 102 (or the behavior level description display unit 101) in such a manner as to be individually distinguished from other rows so that the user can easily differentiate the searched rows. Therefore, the user can easily figure out the respective correspondence relationships between the plural rows of the behavior level description and the plural rows of the RT level description, so that it is convenient for the user.

Note that the present invention is not limited to the foregoing embodiment, and can be changed and modified in various forms.

For example, although in the above embodiment a row selected by the user is highlighted so as to make the user to easily differentiate such a row from other rows, the display manner of the selected row is not limited to this manner. For example, a selected row may be underlined, or the font type thereof may be changed, and in fact, any manners which allow the user to easily distinguish the selected row from other rows can be employed.

The same is true for the display manner of a row corresponding to a row selected by the user.

In the foregoing embodiment, a behavior level description is written in the C language, but may be written in other languages, such as the C++ language and the java language.

The circuit-designing support system 1000 can be realized by a normal computer system, not by an exclusive computer system. For example, a computer program for executing the foregoing operations may be stored in a computer-readable recording medium (e.g., a flexible disk, a CD-ROM, a DVD-ROM or the like) and distributed, and such a computer program is installed in a computer, thereby constituting the circuit-designing support system 1000 which executes the foregoing processes.

Moreover, the computer program may be stored in a storing device of a server device over a communication network like the Internet, and may be downloaded to a normal computer, thereby constituting the circuit-designing support system 1000.

In a case where the function of the circuit-designing support system 1000 is sheared by an OS (Operating System) and an application program or is realized by cooperation of the OS and the application program, for example, merely an application program portion may be stored in a recording medium or a storing device.

Furthermore, the detailed specific structural portions can be appropriately changed and modified.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. A circuit-designing support system which performs behavioral synthesis based on a behavior level description comprised of one or plural rows, and outputs a register transfer level description comprised of one or plural rows, the system comprising:
a behavior level display unit that displays the behavior level description;
a register transfer level display unit that displays the register transfer level description;
a specifying unit that specifies one or plural arbitrary rows of the behavior level description displayed by the behavior level display unit;
a behavior level display control unit that causes the behavior level display unit to display the row of the behavior level description specified by the specifying unit with the specified row being distinguished from other rows;
a searching unit that searches a row of the register transfer level description corresponding to the row of the behavior level description specified by the specifying unit; and
a register transfer level display control unit that causes the register transfer level display unit to display the row of the register transfer level description searched by the searching unit with the searched row being distinguished from other rows.

2. The circuit-designing support system according to claim 1, wherein:
the specifying unit specifies one or plural arbitrary rows of the register transfer level description displayed by the register transfer level display unit;
the register transfer level display control unit causes the register transfer level display unit to display the row of the register transfer level description specified by the specifying unit with the specified row being distinguished from other rows;
the searching unit searches a row of the behavior level description corresponding to the row of the register transfer level description specified by the specifying unit; and
the behavior level display control unit causes the behavior level display unit to display the row of the behavior level description searched by the searching unit with the searched row being distinguished from other rows.

3. The circuit-designing support system according to claim 1, wherein when the specifying unit specifies plural rows of the behavior level description:
the behavior level display control unit causes the behavior level display unit to display the plural rows of the behavior level description with the plural rows being distinguished from one another; and
the register transfer level display control unit causes the register transfer level display unit to display plural rows of the register transfer level description each corresponding to each of the plural rows of the behavior level description with the displayed plural rows being distinguished from one another.

4. The circuit-designing support system according to claim 2, wherein when the specifying unit specifies plural rows of the register transfer level description:
the register transfer level display control unit causes the register transfer level display unit to display the plural rows of the register transfer level description with the plural rows being distinguished from one another; and
the behavior level display control unit causes the behavior level display unit to display the plural rows of the behavior level description each corresponding to each of the plural rows of the register transfer level description with the displayed plural rows being distinguished from one another.

5. The circuit-designing support system according to claim 1, further comprising a storing unit that stores a correspondence relationship, which is between the behavior level description and the register transfer level description and which is created through a process of performing behavioral synthesis based on the behavior level description and of outputting the register transfer level description, and wherein:
the searching unit refers to the correspondence relationship stored in the storing unit and searches a row of the register transfer level description corresponding to the row of the behavior level description specified by the specifying unit.

6. The circuit-designing support system according to claim 2, further comprising a storing unit that stores a correspondence relationship, which is between the behavior level description and the register transfer level description and which is created through a process of performing behavioral synthesis based on the behavior level description and of outputting the register transfer level description, and wherein:
the searching unit refers to the correspondence relationship stored in the storing unit and searches a row of the behavior level description corresponding to the row of the register transfer level description specified by the specifying unit.

7. A circuit-designing support system which performs behavioral synthesis based on a behavior level description comprised of one or plural rows, and outputs a register transfer level description comprised of one or plural rows, the system comprising:
a behavior level display unit that displays the behavior level description;
a register transfer level display unit that displays the register transfer level description;
a specifying unit that specifies one or plural arbitrary rows of the register transfer level description displayed by the register transfer level display unit;
a register transfer level display control unit that causes the register transfer level display unit to display the row of the register transfer level description specified by the specifying unit with the specified row being distinguished from other rows;
a searching unit that searches a row of the behavior level description corresponding to the row of the register transfer level description specified by the specifying unit; and
a behavior level display control unit that causes the behavior level display unit to display the row of the behavior level description searched by the searching unit with the searched row being distinguished from other rows.

8. The circuit-designing support system according to claim 7, wherein when the specifying unit specifies plural rows of the register transfer level description:
the register transfer level display control unit causes the register transfer level display unit to display the plural rows of the register transfer level description with the plural rows being distinguished from one another; and
the behavior level display control unit causes the behavior level display unit to display the plural rows of the behavior level description each corresponding to each of the plural rows of the register transfer level description with the displayed plural rows being distinguished from one another.

9. The circuit-designing support system according to claim 7, further comprising a storing unit that stores a correspondence relationship, which is between the behavior level description and the register transfer level description and which is created through a process of performing behavioral synthesis based on the behavior level description and of outputting the register transfer level description, and wherein:
the searching unit refers to the correspondence relationship stored in the storing unit and searches a row of the behavior level description corresponding to the row of the register transfer level description specified by the specifying unit.

10. A method of displaying in a circuit-designing support system which performs behavioral synthesis based on a behavior level description comprised of one or plural rows, outputs a register transfer level description comprised of one or plural rows, and displays the register transfer level description on a display device, the method comprising:
a behavior level display step of displaying the behavior level description on the display device;
a register transfer level display step of displaying the register transfer level description on the display device;
a specifying step of specifying one or plural arbitrary rows of the behavior level description displayed on the display device; and
a searching step of searching a row of the register transfer level description corresponding to the row of the behavior level description specified in the specifying step, and wherein:
in the behavior level display step, the row of the behavior level description specified in the specifying step is displayed on the display device while the specified row being distinguished from other rows; and
in the register transfer level display step, the row of the register transfer level description searched in the searching step is displayed on the display device with the searched row being distinguished from other rows.

11. The method according to claim 10, wherein when plural rows of the behavior level description are specified in the specifying step:
in the behavior level display step, the plural rows of the behavior level description are displayed on the display device with the plural rows being distinguished from one another; and
in the register transfer level display step, plural rows of the register transfer level description each corresponding to each of the plural rows of the behavior level description are displayed on the display device with the displayed plural rows being distinguished from one another.

12. A method of displaying in a circuit-designing support system which performs behavioral synthesis based on a behavior level description comprised of one or plural rows, outputs a register transfer level description comprised of one or plural rows, and displays the register transfer level description on a display device, the method comprising:
a behavior level display step of displaying the behavior level description on the display device;
a register transfer level display step of displaying the register transfer level description on the display device;
a specifying step of specifying one or plural arbitrary rows of the register transfer level description displayed on the display device; and
a searching step of searching a row of the behavior level description corresponding to the row of the register transfer level description specified in the specifying step, and wherein:
in the register transfer level display step, the row of the register transfer level description specified in the specifying step is displayed on the display device while the specified row being distinguished from other rows; and
in the behavior level display step, the row of the behavior level description searched in the searching step is displayed on the display device with the searched row being distinguished from other rows.

13. The method according to claim 12, wherein when plural rows of the register transfer level description are specified in the specifying step:
in the register transfer level display step, the plural rows of the register transfer level description are displayed on the display device with the plural rows being distinguished from one another; and
in the behavior level display step, plural rows of the behavior level description each corresponding to each of the plural rows of the register transfer level description are displayed on the display device with the displayed plural rows being distinguished from one another.

14. A computer-readable recording medium storing a program that allow a computer, which performs behavioral synthesis based on a behavior level description comprised of one or plural rows, outputs a register transfer level description comprised of one or plural rows, and displays the register transfer level description on a display device, to function as:
a behavior level display control unit that displays the behavior level description on the display device;
a register transfer level display control unit that displays the register transfer level description on the display device;
a specifying unit that specifies one or plural arbitrary rows of the behavior level description displayed on the display device; and
a searching unit that searches a row of the register transfer level description corresponding to the row of the behavior level description specified by the specifying unit, and wherein:
the behavior level display control unit displays the row of the behavior level description specified by the specifying unit on the display device while the specified row being distinguished from other rows; and
the register transfer level display control unit displays the row of the register transfer level description searched by the searching unit on the display device with the searched row being distinguished from other rows.

15. The computer-readable recording medium according to claim 14, wherein when the specifying unit specifies plural rows of the behavior level description, the program allows:
the behavior level display control unit to display the plural rows of the behavior level description on the display device with the plural rows being distinguished from one another; and
the register transfer level display control unit to display plural rows of the register transfer level description each corresponding to each of the plural rows of the behavior level description on the display device with the displayed plural rows being distinguished from one another.

16. A computer-readable recording medium storing a program that allow a computer, which performs behavioral synthesis based on a behavior level description comprised of one or plural rows, outputs a register transfer level description comprised of one or plural rows, and displays the register transfer level description on a display device, to function as:
a behavior level display control unit that displays the behavior level description on the display device;
a register transfer level display control unit that displays the register transfer level description on the display device;
a specifying unit that specifies one or plural arbitrary rows of the register transfer level description displayed on the display device; and
a searching unit that searches a row of the behavior level description corresponding to the row of the register transfer level description specified by the specifying unit, and wherein:
the register transfer level display control unit displays the row of the register transfer level description specified by the specifying unit on the display device while the specified row being distinguished from other rows; and
the behavior level display control unit displays the row of the behavior level description searched by the searching unit on the display device with the searched row being distinguished from other rows.

17. The computer-readable recording medium according to claim 16, wherein when the specifying unit specifies plural rows of the register transfer level description, the program allows:
the register transfer level display control unit to display the plural rows of the register transfer level description on the display device with the plural rows being distinguished from one another; and
the behavior level display control unit to display plural rows of the behavior level description each corresponding to each of the plural rows of the register transfer level description on the display device with the displayed plural rows being distinguished from one another.
